(19) United States
(12) Patent Application Publication
(10) Pub. No.: US 2020/0074493 A1
(43) Pub. Date: Mar. 5, 2020

(54) SYSTEMS AND METHODS OF BLOCKCHAIN PLATFORM FOR AUTOMATED ASSET BASED PROVISIONING OF RESOURCES

(71) Applicant: 0Chain, LLC, San Jose, CA (US)

(72) Inventor: Saswata Basu, San Jose, CA (US)

(73) Assignee: Saswata Basu, San Jose, CA (US)

(21) Appl. No.: 16/118,414

(22) Filed: Aug. 30, 2018

(51) Int. Cl. G06Q 30/02; G06Q 20/06

(52) U.S. Cl. CPC G06Q 30/0215; G06Q 20/06

(57) ABSTRACT

The systems and methods on a blockchain platform of automated asset provisioning, comprising: timing a period of staking; allocating fixed resources for the period with a fixed valuation; allocating fungible resources for the period with a fungible valuation; establishing a net worth on the blockchain with the fixed and fungible valuation using a multiplier; locking portion of the net worth on the blockchain to participate in a transaction; receiving initial trigger to participate in the transaction on the blockchain; anticipating revised valuation of the net worth for participation on the transaction; calculating a participation constraint for the transaction with revised valuation and a target criterion; and automatically deciding to participate based on reaching a threshold for the participation constraint.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### FIELD OF THE INVENTION

The present invention is in the technical field of cloud computing. More particularly, the present invention is in the technical field of blockchain platform. More particularly, the present invention is in the technical field of automated asset provisioning on a blockchain platform.

### BACKGROUND

Internet is a global computer network providing a variety of information and communication facilities, consisting of interconnected networks using standardized communication protocols. Internet is not owned by a single entity and it operates without a central governing body. The same principles of distributed governance were applied to digital currencies by providing ability to perform digital transactions that existed without support from any underlying institution. The digital ledger that records the transactions in a chain using a mathematical hierarchy is called a blockchain.

The current blockchain platform and related applications known to the industry fall short in multiple ways. The complex and computing intense mathematical calculations needed for the operations of the blockchain platform slow down the overall applications implemented on the blockchain platform. While purely altruistic goals may not promote or incentivize entities to maintain and run a blockchain platform, currently there is no mechanism to promote decentralized services. There are no incentives that promote providing a service or sharing a resource using a blockchain platform. Without proper alignment and incentives for the entities operating and involved in it, a blockchain platform cannot be viable and sustainable for a long period of time.

### SUMMARY OF THE INVENTION

The present invention is systems and methods on a blockchain platform of automated asset provisioning, comprising: timing a period of staking; allocating fixed resources for the period with a fixed valuation; allocating fungible resources for the period with a fungible valuation; establishing a net worth on the blockchain with the fixed and fungible valuation using a multiplier; locking portion of the net worth on the blockchain to participate in a transaction; receiving initial trigger to participate in the transaction on the blockchain; anticipating revised valuation of the net worth for participation on the transaction; calculating a participation constraint for the transaction with revised valuation and a target criterion; and automatically deciding to participate based on reaching a threshold for the participation constraint.

The system and method on a blockchain platform of automated asset provisioning, wherein the revised valuation of the net worth is based on one of the following: earning fungible valuation for providing services; or spending fungible valuation for using services.

The system and method on a blockchain platform of automated asset provisioning, wherein the established net worth on the blockchain accounts for inflation rate.

The system and method on a blockchain platform of automated asset provisioning, wherein the multiplier can be revised only within a set range.

The system and method on a blockchain platform of automated asset provisioning, wherein the multiplier is determined based on type of participation on the transaction.

The system and method on a blockchain platform of automated asset provisioning, wherein the multiplier is determined based on a participating entity role including one of the following: a blobber, a sharder, a miner or a client.

The system and method on a blockchain platform of automated asset provisioning, wherein the blockchain platform has more than one current assigned value of the multiplier at a given time.

The system and method on a blockchain platform of automated asset provisioning, wherein the blockchain platform has a single assigned value of the multiplier at a given time.

The system and method on a blockchain platform of automated asset provisioning, wherein the multiplier value is dependent on the locking portion of the net worth or period of staking.

The system and method on a blockchain platform of automated asset provisioning, further comprising: deallocating fungible resources and decreasing valuation for disregarding one or more rules of the blockchain platform.

### BRIEF DESCRIPTION OF THE DRAWINGS

The embodiments of this invention are illustrated by way of example and not limitation in the figures of the accompanying drawings, in which like references indicate similar elements and in which:

FIG. 1 shows a diagram illustrating an example of a system and method on a blockchain platform of automated asset provisioning.

FIG. 2 shows the different parameters of valuation for a consumer or provider computing system illustrating different subroutines, according to one embodiment.

FIG. 3 is an exploded view of a miner computing system illustrating different modules and functions, according to one embodiment.

FIG. 4 is an exploded view of a provider computing system illustrating different modules and functions, according to one embodiment.

FIGS. 5 and 5A is a list of formulas that justify the automated analysis and decision-making on a blockchain platform, according to one embodiment.

FIG. 6 shows a flowchart illustrating an example of a method on a blockchain platform of automated asset provisioning.

FIG. 7 is a schematic diagram of exemplary computing devices that can be used to implement the methods and systems disclosed herein, according to one embodiment.

### DETAILED DESCRIPTION OF THE INVENTION

The systems and methods on a blockchain platform of automated asset provisioning allow for automated allocation and deallocation of different types of resources based on different parameters and the current environment including inflation and/or supply-demand index. The blockchain platform is decentralized and does not have a controlling authority or supervisory power. There are automated incentives and rules to promote a consumer and/or a provider to interact and commit transactions on the blockchain platform. There are three types of resources: (i) fixed or initial capital costs including, for example, a computing platform etc.; (ii) ongoing expenses or resources including bandwidth, network resources, computing costs etc., and (iii) costs or revenues related to a given transaction including tokens. One or more entities that help or manage the self-regulation on the blockchain platform are miners. A consumer is a client who is an end-user with a computing device who initiates the requests and wants to commit transactions on the blockchain platform. A provider may be a a blobber or a sharder who uses a computing device that processes the applications on the blockchain platform.

Services on a blockchain platform include transactions as well as decentralized cloud resources, for example, digital storage, read, write and computations on the blockchain. Tokens help regulate the services and usage on a blockchain platform. The providers provide resources such as storage, bandwidth, and compute to token holders (consumers or clients). Providers provide a staking period when provider or its resources are available to others on the blockchain. A client locks the requisite number of tokens over a period of time during which services are available to them to request service. Providers are paid using newly issued tokens for the services used by a client.

Different embodiments described herein include components or structures to perform the described functionality. A “component” or a “module” as used in this invention disclosure, includes a dedicated or shared processor and, typically, firmware or software modules executed by the processor. Depending upon implementation-specific or other considerations, a module can be centralized or its functionality distributed. A component or a module can include special purpose hardware, firmware, or software embodied in a computer-readable medium for execution by the processor.

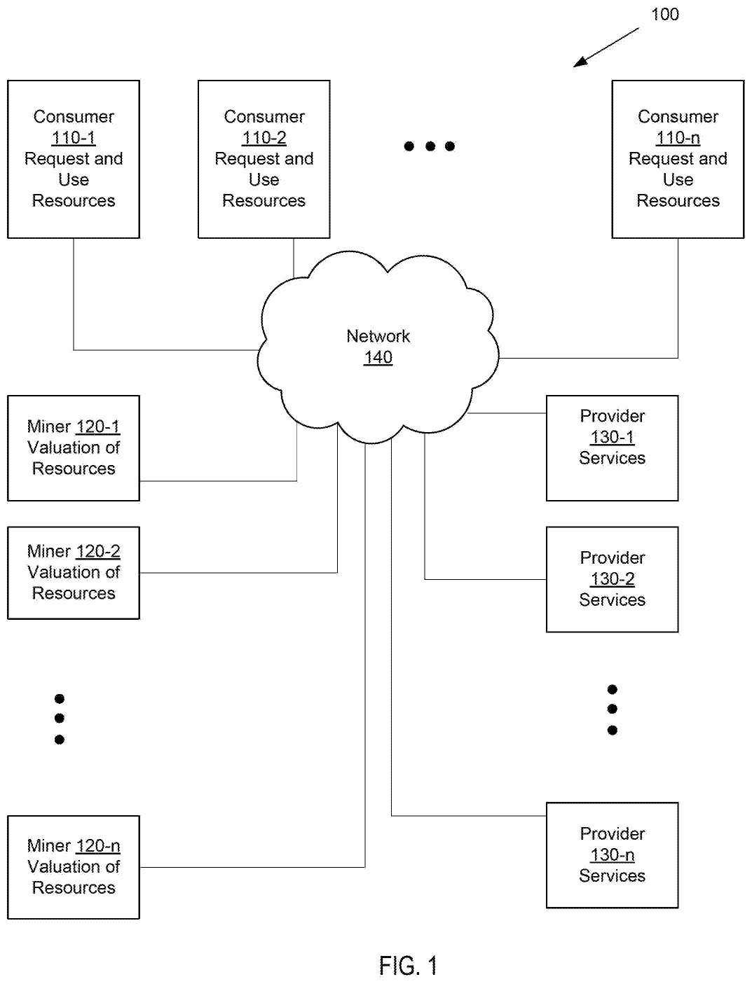

In one embodiment, FIG. 1 depicts a diagram 100 illustrating an example on a blockchain platform of automated asset based provisioning. In the example of FIG. 1, the environment includes a first consumer or client system 110-1 through an nth client system 110-n, network 140, miner system 120-1 through an nth miner system 120-n and a provider or a blobber system 130-1 through an nth blobber system 130-n. In an implementation, the client system 110 includes components related to requesting services from the blockchain platform. In one implementation, the client system 110 requests and uses a storage application for storage, read or write. The miner provides parameters including multipliers to different providers and clients to get a valuation of their net worth. The providers are measured against the quality of service they provide and their performance to fulfill requests that come up on the blockchain. The clients are also measured with following the rules-framework. The miners automatically balance the outstanding tokens with the fixed number of tokens issued by the blockchain network taking into account the tokens that are taken out of circulation. For example, in one embodiment, the locked tokens when using a resource by a client or staked tokens when providing service or a resource are tokens that are taken out of circulation.

Network 140 can be different wireless and wired networks available to connect different computer devices including client and server systems. In an implementation, network 140 is publically accessible on the internet. In an implementation, network 140 is inside a secure corporate wide area network. In an implementation, network 140 allows connectivity of different systems and devices using a computer-readable medium. In an implementation, the blockchain platform allows users on the client system, the blobber or the miner to have customized applications and operational framework.

The messaging and notification between different components can be implemented using application programming interface (API) calls, extensible markup language (“XML”) interfaces between different interfaces, Java/C++ object oriented programming or simple web-based tools. Different components may also implement authentication and encryption to keep the data and the requests secure.

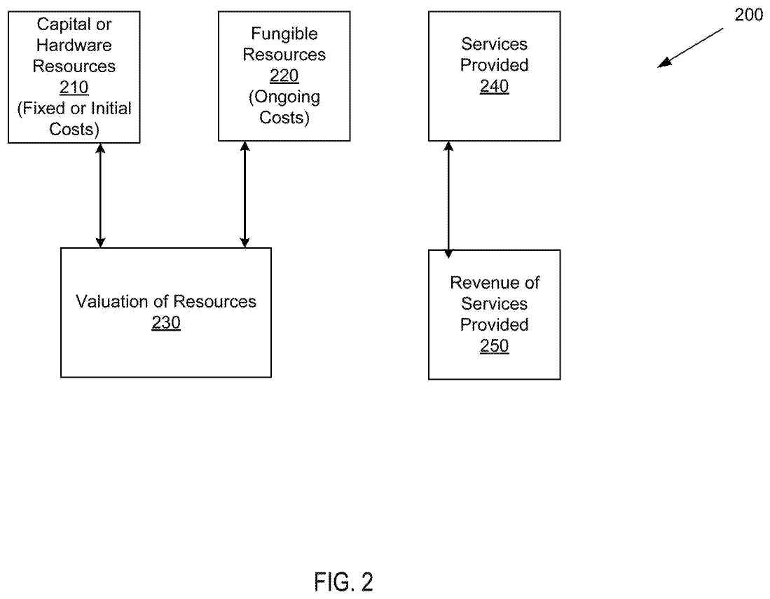

FIG. 2 shows the different parameters of valuation for a consumer or provider computing system 200 illustrating different subroutines, according to one embodiment. For an automated asset based provisioning blockchain platform implementation, the initial stage includes fixed costs with capital or hardware resources 210. The fungible resources 220 are ongoing, cyclic or periodic costs including network bandwidth, computing costs etc. A net worth of an entity can be calculated by sum of its fixed resources and fungible resources. An entity has an opportunity to earn tokens, i.e. revenue of services provided 250 that have additional valuation on providing services 240 on the blockchain platform. An entity also has an opportunity to spend tokens when it requires to use services on the blockchain platform.

In one embodiment related to a storage application, storage providers are called “blobbers.” If a blobber wishes to provide storage, they first place an ask Ps which is the number of tokens the blobber wishes to receive per gigabyte of storage given that the storage must be provided for a staking time period Tₛₜₐₖₑ. If the blobber's ask is accepted, it must stake Ns tokens per gigabyte for the entire period Tₛₜₐₖₑ. The stake enables blobbers to maintain adequate performance of their service and prevent engaging in malicious activities. Blobbers also provide asks for reads (Pr) and writes (Pw). Blobbers need to provide additional stake when clients send data for storage, and get rewarded accordingly and through challenges detailed on a separate white paper. Without loss of generality, we are providing the equations based on a simplified implementation model.

Blobbers receive revenue in terms of tokens on an hourly basis during the staking period for providing storage, reads, and/or writes. Upfront costs include the cost of the tokens needed for staking and capital (e.g. hardware). Blobbers' ongoing costs include colocation services (for storage) and network capacity (for reads and writes). At the end of the staking period, blobbers' receive the residual value of their capital investments and the value of their staked tokens whose price may have decreased (a revenue loss) or increased (a revenue gain). Important to blobbers' decisions to participate in the blockchain network and to their pricing decisions is the expectation of the future value of tokens, both of tokens they receive for providing services, and of their staked tokens. In addition, blobbers will consider alternative investments, and thus discount revenues from the blockchain network by an interest rate adjusted to take into account the riskiness of revenues from the blockchain network versus these alternatives.

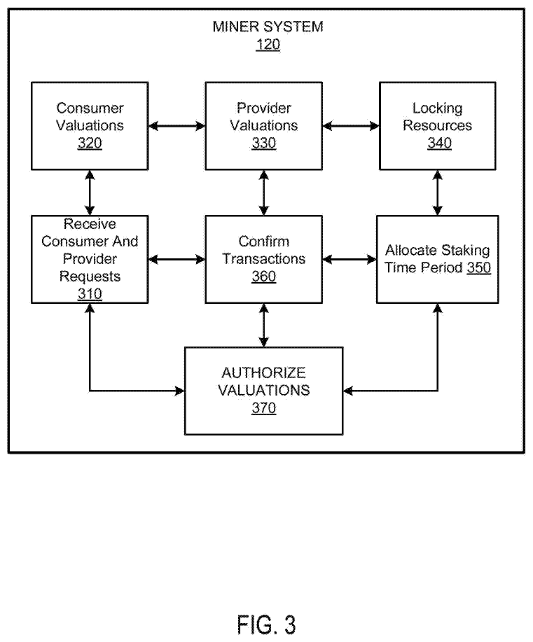

FIG. 3 is an exploded view of a miner system 120 of FIG. 1. The different components or modules included in a miner system includes a module to process and authorize valuations 370, receive consumer and provider requests 310, consumer valuations 320, provider valuations 330, locking resources 340, allocate staking time period 350, and confirm transaction 360 on the blockchain platform.

Both provider and consumer pricing or valuation are regulated by the miner using a multiplier. The multiplier manages the demand and supply on the blockchain platform. In one embodiment, the multiplier adjusts for inflation. For example, inflation rate is fixed at 2 million tokens per n Rounds (where n is number of years since the tokens were created). The miner can use a different value for a provider multiplier and a different one for a consumer valuation. Multiplier for the Miner/Sharder is based on their desire to be selected to be part of an active set. Multiplier for a client can have a minimum and maximum range, for example, multiplier can be set at 1× nominally but can vary from 1× to 5×. Multiplier for the Blobber can have a minimum and maximum range, for example, multiplier can be set at 5× nominally but can vary from 1× to 20×, based on Locked and Staked wallet states.

A locked state is when a consumer is using a portion or all of its net worth to use a service or resource on the blockchain platform. A staked wallet state is when a provider is staking a portion or all of its net worth to provide a service or resource on the blockchain platform. A provider has to be in active listening state to respond to different consumer requests, commit the transactions and then request earnings of tokens based on services provided. A consumer may spend of all its net worth by consuming frequently and may need to invest more to continue to use resources on the blockchain platform. In one embodiment, calculating a participation constraint (i.e. analysis to decide whether to participate or not for a given transaction) for both provider and consumer includes taking into account the locked and/or staked wallet states.

In one embodiment, mechanism is provided for determining dynamic multipliers Mc and Mb to both maximize consumer and provider (for example, blobber) participation in the blockchain network and balance supply and demand of resources given at a fixed token issuance rate.

In one embodiment, mechanism is provided to deallocate fungible resources and decrease the valuation for a blobber, sharder or client when rules are disregarded for the blockchain platform and entities are misbehaving.

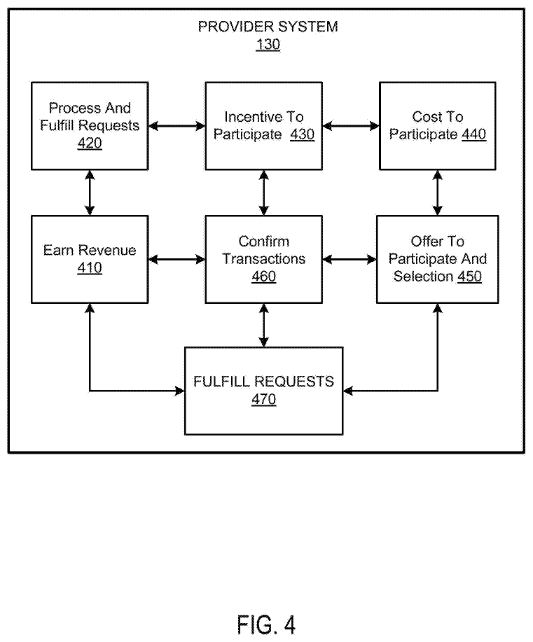

FIG. 4 is an exploded view of a provider system 130 of FIG. 1. The different components or modules included in a miner system includes a module to fulfill requests 470, earn revenue 410, process and fulfill requests 420, incentive to participate 430, cost to participate 440, offer to participate and selection 450 and, confirm transactions 460. In one implementation, the provider is a storage application blobber system. The blobber calculates cost to participate 440 in a given transaction and anticipated revenue earned 430 and decides whether to offer to participate and get selected 450 based on the profit margin for the given transaction and desire to meet certain profit thresholds. The blobber can take into account past and future trends on availability and frequency of transactions. Target criterion can include goals to earn revenue 410 based on confirmation of transactions 460. The cost to the blobber is based on the staking period, staying active and listening to the blockchain platform during the staking period and making reasonable responses to the triggers based on received service requests. As long as the blobber continues to earn revenue and its net worth gets higher and moves towards the blobber's goals, the blobber continues to stay incentivized to participate on the blockchain platform. The blobber does not have to pay any additional taxes to use the blockchain platform.

Clients (including distributed Applications (dApps)) may acquire resources (storage, reads, and writes) from the blockchain network. In order to do so, they select a blobber from whom they want to receive services and lock tokens as determined by blobber's ask prices and the client multiplier (analogous to the blobber multiplier). This is done for a preset locking period determined by the blockchain network, which is the same as the blobbers' staking period. When the locking period is over, clients may again lock their tokens to continue receiving services, hold the tokens for future service acquisition, or sell the tokens. Therefore, tokens may be viewed as an asset for clients, the return being the value of the storage, reads, and writes a client receives per token over the lock period.

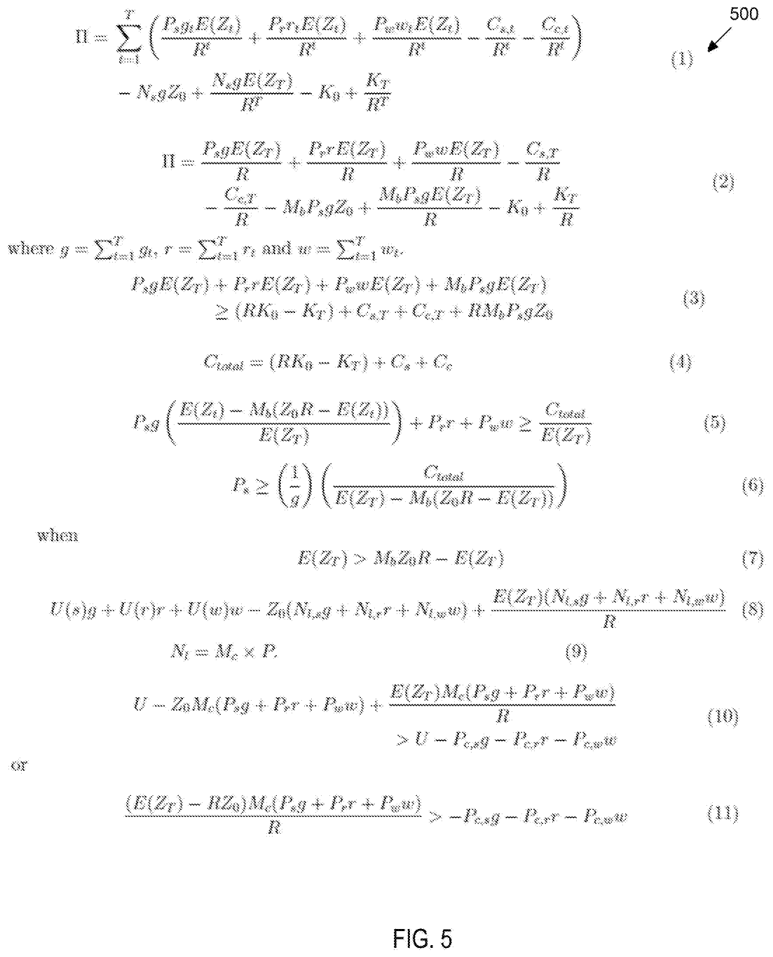

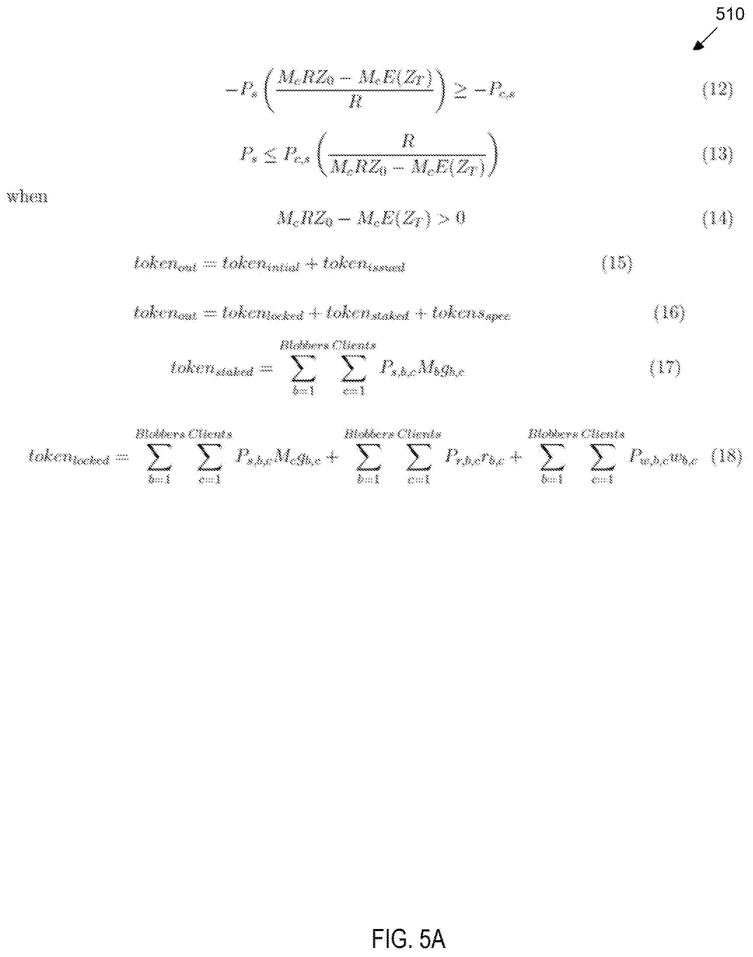

FIGS. 5 and 5A is a list of equations that can be applied to analyze the asset-based provisioning protocol on the blockchain platform. Blobbers want to maximize profitability, π. Revenue comes in the form of the dollar value of tokens received, Zt with the t subscript indicating time (as it will for all other variables). E indicates blobbers expectations, and therefore E(Z)t is the current expectation of the price of the token at time t. C is cost, with the subscript s indicating storage costs and c indicating network capacity costs. Capital (e.g. hardware) is K. g is gigabytes, r is reads, and w is writes. The number of tokens a blobber is required to stake is Ns. The risk-adjusted discount factor is indicated by R. The final period of the staking period is indicated by T, which may be thought of as a block number or time stamp. Ask offer prices are indicated by P, with the subscripts s, r, and w indicating ask offers for storage, reads, and writes, respectively. A blobber's expected profit function in discrete time with the first payout at time t=1 can therefore be written as shown in Equation 1 that assumes the general scenario where blobbers provide their entire stake upfront. Equation 1 can be reduced to two periods without loss of generation. In the true multi-period problem, blobbers will have mitigated risk as token payouts occur more frequently, rather than at the beginning and end of Ts. The amount a blobber must stake per gigabyte is Ns=Mb×Ps where Mb is the blobber multiplier used to adjust staking requirements. Equation 1 can be simplified to Equation 2. Blobbers thus face a participation constraint (the decision whether or not to provide services on the blockchain network) in which total expected revenues must be greater than total costs as shown in Equation 3. In addition, if Blobbers are willing to take purely speculative positions, it is also possible that they would be better off by buying and selling blockchain tokens rather than providing services. In this case, in order for Blobbers to have an incentive to participate, gains from providing services must be greater than costs excluding any gain from staked token price appreciation. This equation can also be used to gain insight into the minimum expected asks. Define total costs as Equation 4. Equation 3 can then be rearranged as Equation 5.

First, equation (5) shows that blobbers can use a combination of prices to cover their costs and earn a profit. For example, a blobber might choose to ask below cost on reads and writes, and instead make up for these lower asks by charging a higher price on storage—whatever combination they might use will likely be determined by the observed behaviors in the blockchain market. Isolating components of equation (5) provides further insights into blobber pricing. Focusing on storage by setting r=w=0 as shown in Equation 6 and 7.

Equations (6) and (7) show that as E(Z_{T}) approaches RZO from above (that is, blobbers expect little appreciation or in fact depreciation of the blockchain token, adjusted for risk) profitable ask levels go to infinity unless the multiplier Mb is adjusted downwards. In fact, Mb can be 0—no staking requirement for blobbers. Thus, Mb is one tool which blockchain may use to influence profitable ask levels, though there are adverse consequences of lowering Mb. When equation (7) does not hold, the inequality in equation (6) is reversed, in which case asks would need to be negative to be profitable. Thus, when significant token depreciation is expected over the staking period, blobbers will not offer storage.

The requisite number of locked tokens, Nₗ, per unit of service (gigabyte, read, or write) are locked for time period T_{lock}. Nₗ may be broken down into three sub components: N_{l,s} is tokens locked per gigabyte of storage, N_{l,r} is tokens locked per read, and N_{l,w} is tokens locked per write.

Clients receive a benefit from using services on the blockchain network, subject to the cost of holding tokens and the tokens' resale value. The benefit (“utility” in economic terms) for one gigabyte of storage is denoted as U (s), U (r) is the benefit from one read, and U (w) is the benefit from one write. The upfront cost to a client is the total purchase price of tokens for locking, calculated as the the token price at the beginning of the locking period times the requisite number of tokens. However, after the locking period is over, the clients reclaim these tokens whose value is then based upon the end of locking period price. Mathematically, Equation 8.

Similar to the blobber multiplier, clients also have a multiplier, here denoted as Me. The client multiplier, along with the blobber's ask price, is used to determine the number of locked tokens required to receive services from the blobbers, i.e. Equation 9.

When clients are deciding whether or not to acquire services on the blockchain network, they will compare blockchain to competitive alternatives. Denote P_{c,s} as the competitor's price for one gigabyte of storage, P_{c,r} as the price for one read, and P_{c,w} as the price of one write over Tock. Total utility U can be defined as U(s)g+U(r)r+U(w)w, and presumably clients will receive similar utility for using resources from the blockchain network or a competitor. We can then write the client's decision to use blockchain over a competitor's service (the client's “participation constraint”) as Equation 10 or 11.

As long as the left hand side of Equation (11) is greater than the right hand side, clients would prefer blockchain services over a competitive substitute. Focusing on storage by setting r=w=0 and simplifying as Equation 12 and 13 when 14 is met.

If equation (14) does not hold, meaning that the expected future price of the token is greater than the current price adjusted for risk, the inequality in equation (13) is reversed. In this case, clients would participate at any storage ask price Pₛ, as the expected return to holding tokens would be positive, even excluding any benefit from using blockchain network services.

Similar (but inverse) to the pricing dynamics with blobbers, equation (13) suggests that as E(Zₜ) decreases below Z₀, the price per gigabyte of storage required for a client's participa-tion in the blockchain network becomes smaller. That is, even though services are technically free in that clients don't directly pay for the services, if the value of the required asset hold-ing (tokens) is expected to decrease significantly, clients may decide not to use the blockchain network. However, as equation (13) shows, by decreasing M_{c}, a decrease in E(Zₜ) can at least be partially offset. In fact, by setting M_{c}=0, clients face no direct financial loss from using blockchain network services.

The number of tokens outstanding is Equation 15, where tokenintial is the initial amount of tokens outstanding, and tokenissued is the cumulative number of tokens issued to blobbers. Therefore, tokenout is always greater than tokenissued. Thus, there is the potential that at a given price, the quantity demanded and quantity supplied of resources will not match as clients may claim more resources via locking than blobbers can be paid for by token issuance. The use of the client side multiplier Mc helps offset this issue by creating separation between the quantity of locked tokens needed to ac-quire a given resource and the quantity of tokens paid to blobbers for providing the resource. This can be more easily seen by breaking down token holdings as Equation 16, where, at any given point in time, token_{locked} is the total number of tokens locked by clients, token_{staked} is the total number of tokens staked by blobbers, and tokens_{spec} is the total number of tokens held for speculative purposes.

Making the assumption that a client-blobber relationship occurs at one ask price8, and making the generalization that all resources are allocated and used by the client, we can represent that total number of tokens staked at any point in time as Equation 17, where Blobbers is the total number of blobbers, Clients is the total number of clients, Ps,b,c is the ask offer in tokens per gigabyte by blobber b for client c, and gb,c is the number of gigabytes allocated by blobber b to client c.

Clients lock tokens in order to acquire storage, reads, or writes. The total number of tokens locked by clients, is therefore Equation 18. Here, Pr,b,c and Pw,b,c are the ask prices for reads and writes, respectively, between blobber b and client c, and rb,c and wb,c are the number of reads and writes allocated from blobber b to client c.

Equation (18) determines the total number of tokens that need to be staked and locked for a given amount of resources (storage, reads, and writes), assuming the percent of tokens held for speculation remains relatively constant (or exogenously determined). Increasing M_{c} increases the total locking requirement for clients, therefore reducing the quantity of resources that can be demanded by clients for a given level of client token holdings. Like-wise, increasing Mb increases the number of tokens needed for staking by blobbers, therefore reducing the amount of services that can be provided by blobbers for a given level of blobber token holdings. Thus, M_{c} and M_{b} may be adjusted to offset supply and demand quantity imbalances. However, changes in these multipliers will also have impacts on resource pricing and client/blobber network participation, as already described in the previous sections.

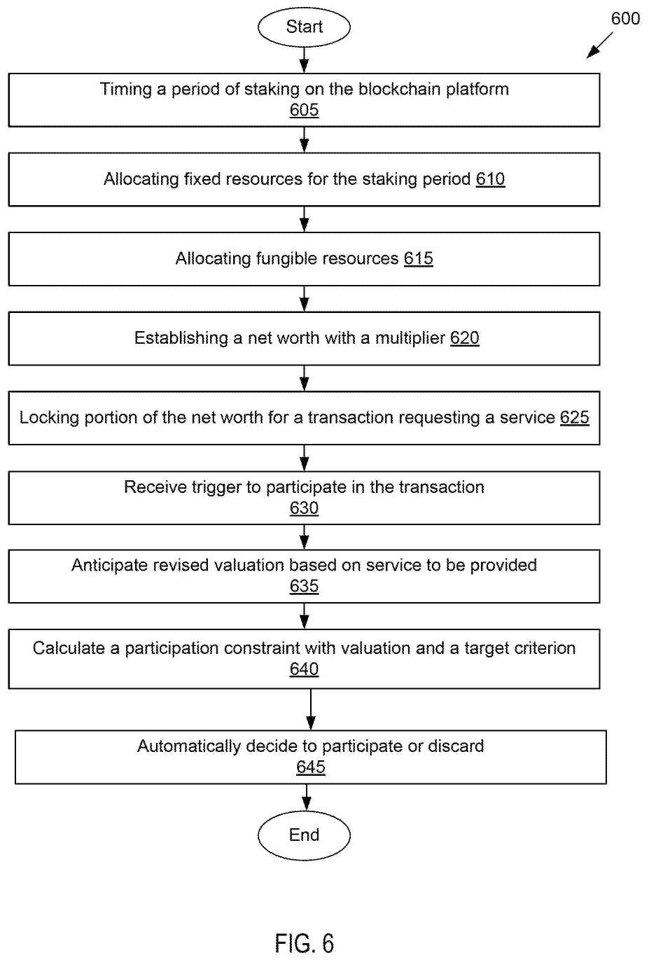

FIG. 6 depicts a flowchart 600 illustrating an example of a method for a blockchain platform with automated asset-based provisioning. The flowchart 600 is discussed in conjunction with the blockchain platform environment shown in the diagram 100 in FIG. 1. At block 605, for given transactions, there is a timing a period of staking when the providers make resources or services available on the blockchain platform. At block 610, fixed resources are allocated to the provider for the staking period that include initial setup costs, capital or hardware. At block 615, fungible resources including ongoing costs and tokens are allocated. At block 620, a net worth is established using a multiplier for valuation of the provider, consumer or any other entity based on available fixed and fungible resources. At block 625, a consumer engages in locking portion or all of the net worth for a transaction requesting service. At block 630, the consumer initiates a trigger that is received on the blockchain platform making a request to use a service or a transaction. At block 635, after actively listening to the incoming consumer requests, the provider anticipates revised valuation based on cost of fulfilling the service and revenue earned for providing the service. At block 640, the provider calculates a participation constraint with valuation and any target criterion. For example, target criterion could be based on past or future trends in transactions. In one embodiment, target criterion could be based on increase in revenue or profits desired by the provider. If anticipated profit for the given transaction is low, a provider may disregard the transaction and not actively participate to be selected to commit the transaction. In one embodiment, the target criterion includes one or more environment parameters. In one embodiment, the target criterion includes its own net worth and availability of resources. At block 645, the provider automatically decides whether to participate in the given transaction based on whether a threshold is met for the calculated participation constraint.

In broad embodiment, the invention is systems and methods of a blockchain platform for automated asset based provisioning of resources is driven by automated calculation of participation constraint for a blobber and/or a client and making a decision based on target criterion to achieve increasing valuation based on assigned multiplier.

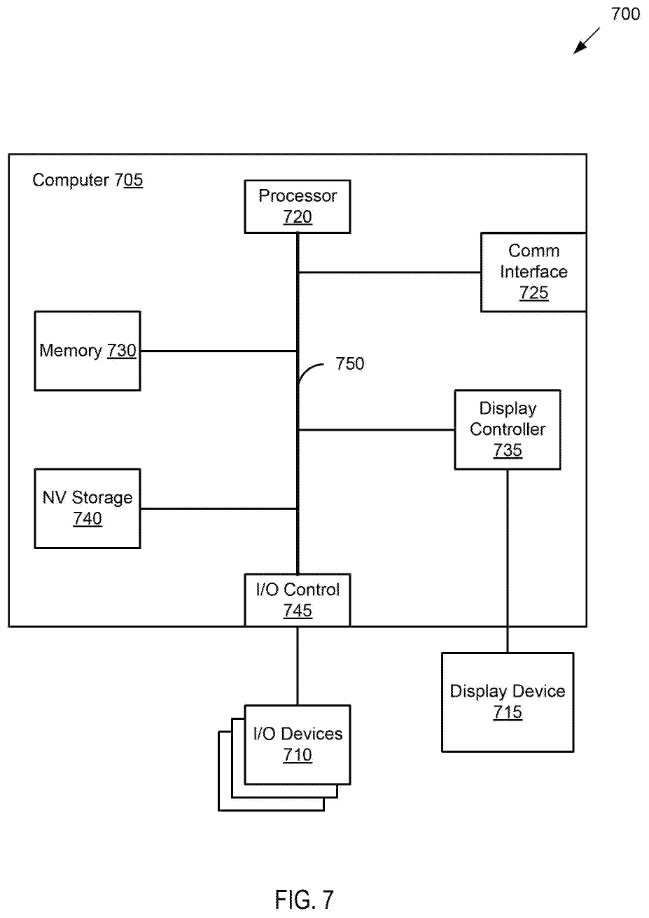

FIG. 7 is a schematic diagram of computing device 700 that can be used to implement the methods and systems disclosed herein, according to one or more embodiments. FIG. 7 is a schematic of a computing device 700 that can be used to perform and/or implement any of the embodiments disclosed herein. In one or more embodiments, client system 110, a miner system 120 and/or blobber system 130 of FIG. 1 may be the computing device 700.

The computing device 700 may represent various forms of digital computers, such as laptops, desktops, workstations, personal digital assistants, servers, blade servers, mainframes, and/or other appropriate computers. The computing device 700 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

FIG. 7 shows an example of a computing device 700 on which techniques described here can be implemented. The computing device 700 can be a conventional computer system that can be used as a client computer system, such as a wireless client or a workstation, or a server computer system. The computing device 700 includes a computer 705, I/O devices 710, and a display device 715. The computer 705 includes a processor 720, a communications interface 725, memory 730, display controller 735, non-volatile storage 740, and I/O controller 745. The computer 705 may be coupled to or include the I/O devices 710 and display device 715.

The computer 705 interfaces to external systems through the communications interface 725, which may include a modem or network interface. It will be appreciated that the communications interface 725 can be considered to be part of the computing device 700 or a part of the computer 705. The communications interface 725 can be an analog modem, integrated services for digital networks (“ISDN”) modem, cable modem, token ring interface, satellite transmission interface (e.g. “direct personal computer” also known as “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 710 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computing device 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings described here. Network computers do not usually include a hard disk or other mass storage, and the executable programs are loaded from a network connection into the memory 730 for execution by the processor 720. A Web TV system, which is known in the art, is also considered to be a computer system, but it may lack some of the components shown in FIG. 7, such as certain input or output devices. A typical computer system will usually include at least a processor, memory, and a bus coupling the memory to the processor.

Though FIG. 7 shows an example of the computing device 700, it is noted that the term “computer system,” as used here, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described here, including clients, servers, and engines, can be compatible with or implemented using a cloud-based computing system. As used here, a cloud-based computing system is a system that provides computing resources, software, and/or information to client systems by maintaining centralized services and resources that the client systems can access over a communications interface, such as a network. The cloud-based computing system can involve a subscription for services or use a utility pricing model. Users can access the protocols of the cloud-based computing system through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described here relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The structures and modules in the figures may be shown as distinct and communicating with only a few specific structures and not others. The structures may be merged with each other, may perform overlapping functions, and may communicate with other structures not shown to be connected in the figures.

1. A method on a blockchain platform of automated asset provisioning, comprising:
timing a period of staking;
allocating fixed resources for the period with a fixed valuation;
allocating fungible resources for the period with a fungible valuation;
establishing a net worth on the blockchain with the fixed and fungible valuation using a multiplier;
locking portion of the net worth on the blockchain to participate in a transaction;
receiving initial trigger to participate in the transaction on the blockchain;
anticipating revised valuation of the net worth for participation on the transaction;
calculating a participation constraint for the transaction with revised valuation and a target criterion; and
automatically deciding to participate based on reaching a threshold for the participation constraint.

2. The method of claim 1, wherein the revised valuation of the net worth is based on one of the following:
(i) earning fungible valuation for providing services; or
(ii) spending fungible valuation for using services.

3. The method of claim 1, wherein the established net worth on the blockchain accounts for inflation rate.

4. The method of claim 1, wherein the multiplier can be revised only within a set range.

5. The method of claim 1, wherein the multiplier is determined based on type of participation on the transaction.

6. The method of claim 1, wherein the multiplier is determined based on a participating entity role including one of the following: a blobber, a sharder, a miner or a client.

7. The method of claim 1, wherein the blockchain platform has more than one current assigned value of the multiplier at a given time.

8. The method of claim 1, wherein the blockchain platform has a single assigned value of the multiplier at a given time.

9. The method of claim 1, wherein the multiplier value is dependent on the locking portion of the net worth or period of staking.

10. The method of claim 1, further comprising:
deallocating fungible resources and decreasing valuation for disregarding one or more rules of the blockchain platform.

11. A system on a blockchain platform of automated asset provisioning, comprising:
a timing module to determine a period of staking;
an allocating-fixed module to allocate fixed resources for the period with a fixed valuation;
an allocating-fungible module to allocate fungible resources for the period with a fungible valuation;
an establishing module to establish a net worth on the blockchain with the fixed and fungible valuation using a multiplier;
a locking-module to lock a portion of the net worth on the blockchain to participate in a transaction;
a receiving module to receive an initial trigger to participate in the transaction on the blockchain;
an anticipating module to anticipate revised valuation of the net worth for participation on the transaction;
a calculating module to calculate a participation constraint for the transaction with revised valuation and a target criterion; and
an automatically deciding module to decide to participate based on reaching a threshold for the participation constraint.

12. The system of claim 11, wherein the revised valuation of the net worth is based on one of the following:
(iii) an earning module to earn fungible valuation for providing services; or
(iv) a spending module to spend fungible valuation for using services.

13. The system of claim 11, wherein the established net worth on the blockchain accounts for inflation rate.

14. The system of claim 11, wherein the multiplier can be revised only within a set range.

15. The system of claim 11, wherein the multiplier is determined based on type of participation on the transaction.

16. The system of claim 11, wherein the multiplier is determined based on a participating entity role including one of the following: a blobber, a sharder, a miner or a client.

17. The system of claim 11, wherein the blockchain platform has more than one current assigned value of the multiplier at a given time.

18. The system of claim 11, wherein the blockchain platform has a single assigned value of the multiplier at a given time.

19. The system of claim 11, wherein the multiplier value is dependent on the locking portion of the net worth or period of staking.

20. The system of claim 11, further comprising:
deallocating module to deallocate fungible resources and module to decrease valuation for disregarding one or more rules of the blockchain platform.
